(19) United States
(12) Patent Application Publication
(10) Pub. No.: US 2025/0028032 A1
(43) Pub. Date: Jan. 23, 2025

(54) HISTOGRAM GENERATING CIRCUIT, OPTICAL RANGEFINDER, HISTOGRAM GENERATION METHOD, AND OPTICAL RANGING METHOD

(71) Applicant: HOKUYO AUTOMATIC CO., LTD., Osaka-shi, Osaka (JP)

(72) Inventor: Kunihiro YASUDA, Osaka-shi (JP)

(73) Assignee: HOKUYO AUTOMATIC CO., LTD., Osaka-shi, Osaka (JP)

(21) Appl. No.: 18/716,660

(22) PCT Filed: Dec. 2, 2022
(86) PCT No.: PCT/JP2022/044503

§ 371 Date: Jun. 5, 2024

(30) Foreign Application Priority Data
Dec. 13, 2021 (JP) 2021-201450

(51) Int. Cl. G01S 7/4865; G01S 7/481; G01S 17/10

(52) U.S. Cl. CPC G01S 7/4865; G01S 7/4816; G01S 17/10

(57) ABSTRACT

A histogram generating circuit generates a histogram based on respective flight information that is a time of flight or a flight distance from an emission time point of measurement light repeatedly emitted at predetermined periods to a detection time point of reflected light for respective measurement light, the histogram showing a cumulative frequency of the flight information distributed in a preset measurement range, the histogram generating circuit including: a memory circuit configured to store the histogram; and a memory processing circuit configured to associate a bin number for identifying each bin obtained by splitting the measurement range into a plurality of divisions individually in order based on the flight information with the flight information contained in each bin and the cumulative frequency, and store them in the memory circuit, thereby effectively using a limited memory area.

### TECHNICAL FIELD

The present invention relates to a histogram generating circuit, an optical rangefinder, a histogram generation method, and an optical ranging method, and more particularly to a histogram generating circuit, an optical rangefinder, a histogram generation method, and an optical ranging method suitable for a case of using a photon counting type light receiving element.

### BACKGROUND ART

Patent Literature 1 discloses a photodetector intended to provide, in a laser radar using a histogram for calculating a time of flight of light, a technique that can reduce a memory capacity for storing a histogram as compared to prior arts.

The photodetector includes: a light reception array unit having a plurality of light reception units configured to output a pulse signal in response to an incidence of a photon, the light reception array unit configured to receive reflected light irradiated from an irradiation unit and reflected by an object, and output in parallel the pulse signal output from each of the plurality of light reception units; a timer unit configured to measure an elapsed time since timing at which the irradiation unit irradiates light; a count unit configured to count, as a number of responses, the number of the light reception units outputting the pulse signal among the plurality of light reception units at each fixed cycle timing, and output an adjusted number of responses obtained by subtracting a preset bias value from the number of responses or dividing the number of responses by the bias value; a memory whose address is associated with a timer value measured by the timer unit; and a histogram generation unit configured to generate a histogram by repeating a preset number of times a process of integrating, in the address of the memory specified from a timer value in the timer unit, the adjusted number of responses as data at the address.

According to the photodetector, since the adjusted number of responses that is smaller than the number of responses is integrated upon generating a histogram, a memory capacity can be reduced compared to a case where the number of responses is integrated as it is.

### CITATION LIST

### Patent Literature

Patent Literature 1: Japanese Unexamined Patent Application Publication No. 2018-169384

### SUMMARY OF INVENTION

### Technical Problem

However, in the photodetector disclosed in Patent Literature 1, there is a problem that a memory area with no time value present is wasted because the address of the memory used for generating a histogram is associated with the timer value measured by the timer unit, specifically, because it is necessary to prepare an address space corresponding to the number of time bins set to cover the entire time range that can be measured by the photodetector.

Moreover, since the total number of bins and a data bit width of the bin also increase depending on ranging resolution, there is a problem that the memory capacity wastefully increases as a longer measurement distance is measured with higher resolution.

It is an object of the present invention to provide a histogram generating circuit, an optical rangefinder, a histogram generation method, and an optical ranging method that enable effective use of a limited memory area, thereby reducing a memory capacity.

### Solution to Problem

To achieve the above object, as a first feature of the histogram generating circuit in accordance with the present invention, the histogram generating circuit generates a histogram based on respective flight information that is a time of flight or a flight distance from an emission time point of measurement light repeatedly emitted at predetermined periods to a detection time point of reflected light for respective measurement light, the histogram showing a cumulative frequency of the flight information distributed in a preset measurement range, the histogram generating circuit including: a memory circuit configured to store the histogram; and a memory processing circuit configured to associate a bin number for identifying each bin obtained by splitting the measurement range into a plurality of divisions individually in order based on the flight information with the flight information contained in each bin and the cumulative frequency, and store the bin number, the flight information, and the cumulative frequency in the memory circuit.

Since the memory processing circuit associates the occurred flight information having the bin number for identifying the bin to which the flight information belongs individually in order based on the flight information that is the time of flight or the flight distance, and stores them in the memory circuit, there is no need to secure in advance a memory area corresponding to the bin with no occurrence of the time of flight, allowing to reduce a memory capacity. Further, in a case that a plurality of pieces of flight information occurs for the same bin number, the memory processing circuit can associate the bin number with the cumulative frequency, thereby generating the histogram showing the cumulative frequency of the flight information distributed in the preset measurement range. Note that as the flight information, it is preferable to use the time of flight from the emission time point of the measurement light to the detection time point of the reflected light for the respective measurement light, but it is also possible to use the flight distance corresponding to the time of flight.

In addition to the first feature described above, the histogram generating circuit in accordance with the present invention has a second feature that when the flight information occurs, the memory processing circuit reads out the bin number stored in the memory circuit, sorts the flight information in ascending or descending order by the bin numbers including the one to which the flight information occurred this time belongs, and stores the bin numbers, the flight information, and the cumulative frequency in the memory circuit.

To search for a bin number to which newly occurred flight information belongs, the memory processing circuit reads out the respective bin numbers previously stored from the memory circuit, and compares the read out bin numbers with the bin number to which the newly occurred flight information belongs. Then, it sorts the respective bin numbers in ascending or descending order and stores the updates in the memory circuit. In this case, if there is the same bin number as the bin number to which the new flight information belongs, the memory processing circuit can store the updates in the memory circuit after adding 1 to the cumulative frequency for that bin number, thereby updating the cumulative frequency.

In addition to the first feature described above, as a third feature, the histogram generating circuit in accordance with the present invention includes, as the memory circuit, a memory circuit for reference to grasp an already stored bin number and a memory circuit for storage to store bin numbers including a new bin number and the cumulative frequency when the flight information occurs, wherein the memory processing circuit is configured to switch functions of the memory circuit for reference and the memory circuit for storage for each occurrence of the flight information; read out a bin number stored in the memory circuit for reference; sort the flight information in ascending or descending order by the bin numbers including the one to which the flight information occurred this time belongs; and store the bin numbers, the flight information, and the cumulative frequency in the memory circuit for storage.

Two memory circuits are provided as the memory circuit: the memory circuit for reference to grasp the already stored bin number and the memory circuit for storage to store the bin numbers including the new bin number and the cumulative frequency. Based on the bin numbers and the cumulative frequency stored in the memory circuit for storage by the memory processing circuit, the most recent histogram will be created. When new flight information occurs, the memory processing circuit causes the memory circuit for storage to function as the memory circuit for reference, and compares the bin number read out from the memory circuit for reference with the bin number to which the new flight information belongs. Then, it sorts the respective flight information such that the respective bin numbers are in ascending or descending order, and stores the bin numbers, the flight information, and the cumulative frequency in the memory circuit for storage whose function is switched from the memory circuit for reference. By separating the functions into the memory circuit for reference and the memory circuit for storage, it is possible to simultaneously perform readout processing from one of the memory circuits and write processing in the other memory circuit, increasing a processing speed as compared to a case of using a single memory circuit.

In addition to the third feature described above, the histogram generating circuit in accordance with the present invention has a fourth feature that the memory processing circuit stores the bin number, the flight information, and the cumulative frequency in the memory circuit for storage without switching the functions of the memory circuit for reference and the memory circuit for storage at first occurrence of the flight information.

At the first occurrence of the flight information, there is no need to compare the bin numbers so that any one of the memory circuits may function as the memory circuit for storage to store the bin number, the flight information, and the cumulative frequency (“1” in this case).

In addition to the first feature described above, as a fifth feature, the histogram generating circuit in accordance with the present invention further includes a FIFO-type memory circuit, wherein the FIFO-type memory circuit includes a write circuit configured to store the flight information in synchronization with occurrence of the flight information, and a readout circuit configured to read out and output the flight information to the memory processing circuit asynchronously to the occurrence of the flight information.

The memory processing circuit stores the flight information in the FIFO-type memory circuit via the write circuit included in the FIFO-type memory circuit in synchronization with the occurrence of the flight information. Additionally, the memory processing circuit reads out the flight information stored in the FIFO-type memory circuit via the readout circuit included in the FIFO-type memory circuit asynchronously to the occurrence of the flight information, calculates the corresponding bin number based on the read out flight information, and updates the histogram in accordance with the first feature described above. Even if an occurrence interval of the flight information is short, such configuration enables to buffer the respective flight information in the FIFO-type memory circuit and secure a time to update the histogram based on the respective flight information subsequently read out via the readout circuit, causing no inconvenience of data loss.

In addition to the fifth feature described above, the histogram generating circuit in accordance with the present invention has a sixth feature that the write circuit is configured to store dummy data indicating an end of output of the flight information in one period in the FIFO-type memory circuit every time the output of the flight information ends at the predetermined periods, and the readout circuit is configured to output a signal indicating an end of output of the flight information in one period every time when reading out the dummy data.

When the occurred flight information is sequentially written in the FIFO-type memory circuit via the write circuit, there is a possibility that it will not be easy to determine to which period of the measurement light repeatedly emitted at the predetermined periods, the respective flight information read out via the readout circuit belongs. Even in such case, by storing the dummy data indicating the end of output of the flight information in one period in the memory circuit, it is possible to easily recognize the end of the flight information in one period.

As a first feature of the optical rangefinder in accordance with the present invention, the optical rangefinder includes: a light emitting element configured to emit pulsed measurement light; a plurality of photon counting type light receiving elements configured to detect reflected light from an object for the measurement light; an adder circuit configured to add voltage pulses output from the respective light receiving elements; a flight information calculation circuit configured to calculate, as flight information, time from an emission time point of the measurement light to a time point at which a sum from the adder circuit reaches a predetermined addition threshold, or a distance corresponding to the time; a histogram generating circuit including any of the first to sixth features, configured to generate a histogram showing a cumulative frequency of the flight information distributed in a preset measurement range based on the flight information calculated by the flight information calculation circuit when the measurement light is repeatedly emitted at predetermined periods; a representative value calculation circuit configured to calculate a representative value of the flight information for the object from the flight information that is distributed in the bin of the bin number where the frequency reaches a predetermined histogram threshold based on the histogram; and a distance calculation circuit configured to calculate a distance to the object based on the representative value of the flight information calculated by the representative value calculation circuit.

Based on the histogram generated by the histogram generating circuit including any of the first to sixth features, the representative value of the times of flight for the object, that is, more reliable flight information, is calculated from the times of flight distributed in the range where the frequency reaches the predetermined histogram threshold by the representative value calculation circuit. Based on such flight information, the distance to the object is properly calculated by the distance calculation circuit.

As a first feature of the histogram generation method in accordance with the present invention, the histogram generation method for generating a histogram based on respective flight information that is a time of flight or a flight distance from an emission time point of measurement light repeatedly emitted at predetermined periods to a detection time point of reflected light for respective measurement light, the histogram showing a cumulative frequency of the flight information distributed in a preset measurement range, includes: a memory step of storing the histogram in a memory circuit; and a memory processing step of associating a bin number for identifying each bin obtained by splitting the measurement range into a plurality of divisions individually in order based on the flight information with the flight information contained in each bin and the cumulative frequency, and storing the bin number, the flight information, and the cumulative frequency in the memory circuit.

As a first feature of the optical ranging method in accordance with the present invention, the optical ranging method includes: a reflected light detection step of detecting reflected light from an object for pulsed measurement light emitted from a light emitting element using a plurality of photon counting type light receiving elements; a flight information calculation step of calculating, as flight information, a time from an emission time point of the measurement light to a time point at which a sum of voltage pulses output from the respective light receiving elements reaches a predetermined addition threshold, or a distance corresponding to the time; a histogram generation step of performing a histogram generation method including the first feature, generating a histogram showing a cumulative frequency of the flight information distributed in a preset measurement range based on the flight information calculated in the flight information calculation step when the measurement light is repeatedly emitted at predetermined periods; a representative value calculation step of calculating a representative value of the flight information for the object from the flight information distributed in the bin of the bin number where the frequency reaches a predetermined histogram threshold based on the histogram; and a distance calculation step of calculating a distance to the object based on the representative value of the flight information calculated in the representative value calculation step.

### Advantageous Effects of Invention

As described above, according to the present invention, it is possible to provide the histogram generating circuit, the optical rangefinder, the histogram generation method, and the optical ranging method that enable effective use of a limited memory area, thereby reducing a memory capacity.

### BRIEF DESCRIPTION OF DRAWINGS

FIG. 1 illustrates a configuration of an optical rangefinder in accordance with the present invention.

FIG. 2 illustrates a light receiving circuit.

FIG. 3 illustrates a histogram generating circuit.

FIG. 4 illustrates operation of a histogram generating circuit and a representative value calculation circuit.

FIG. 5 illustrates operation of the histogram generating circuit and the representative value calculation circuit, showing another aspect.

FIG. 6 illustrates processing for writing data in and reading out data from a FIFO-type memory circuit.

FIG. 7 illustrates a procedure for generating a histogram using a single memory circuit.

FIG. 8 illustrates a procedure for generating a histogram using two memory circuits.

FIG. 9 illustrates a procedure for generating a histogram using two memory circuits.

### BEST MODE FOR CARRYING OUT THE INVENTION

The optical rangefinder and the optical ranging method in accordance with the present invention, as well as the histogram generating circuit and the histogram generation method used therefor will be described below.

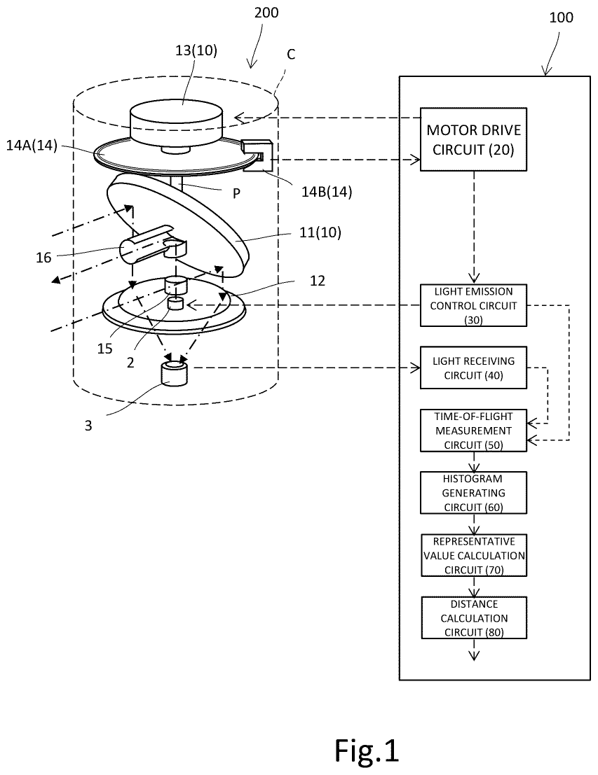

As shown in FIG. 1, an optical rangefinder 200 is a TOF optical rangefinder including: a light emitting element 2 housed in a casing C equipped with a light transmissive window and emitting pulsed measurement light; a plurality of photon counting type light receiving elements 3 that detects reflected light from an object for the measurement light; an optical scanning device 10 that scans with the measurement light emitted from the light emitting element 2 toward a measurement space and guides the reflected light diffusely reflected from a surface of the object present in the measurement space to the light receiving elements 3; and a control circuit 100 to operate the optical scanning device 10 while driving the light emitting element 2, and process a signal for the reflected light detected by the light receiving elements 3 to calculate a distance to the object.

The optical scanning device 10 includes: a deflection mirror 11 to deflect the measurement light emitted from the light emitting element 2 toward the measurement space and guide the reflected light from the object to the light receiving elements 3; a motor 13 to rotate the deflection mirror 11 about a rotary shaft P; and an encoder 14 to detect a rotation speed and a rotation position of the motor 13.

The encoder 14 is configured with a disc 14A that has slits formed at predetermined intervals on the outer periphery thereof and rotates about the rotary shaft P, and a transmissive photointerrupter 14B to detect light passing through the slits formed on the disc 14A.

The deflection mirror 11 is fixed at a 45 degree orientation relative to the rotary shaft P, and the light receiving elements 3, a collecting lens 12, the light emitting element 2, and a projection lens 15 are arranged on the axis of the rotary shaft P, respectively. The pulsed measurement light emitted from the light emitting element 2 is shaped into parallel light as it passes through the projection lens 15, and then propagates along a light guide 16. The measurement light is then deflected at right angles by the deflection mirror 11 and emitted to a monitored area while being deflected for scanning along with rotation of the deflection mirror 11.

The reflected light from the object propagates through the space around the light guide 16 and impinges on the deflection mirror 11, where the reflected light is deflected in the axial direction of the rotary shaft P and then passes through the collecting lens 12 to enter the light receiving elements 3. Note that the optical scanning device 10 described above is illustrative and not limited to this configuration as long as the optical scanning device can scan with or deflect the measurement light emitted from the light emitting element 2 in a predetermined direction, and guide the reflected light thereof to the light receiving elements 3. For example, it is possible to employ: a configuration including a polygon mirror that rotates at a constant speed or a deflection mirror that oscillates using driving force of a piezoelectric element or the like; a configuration where an entire optical system is rotated; a configuration where an entire optical system including the light emitting element 2 and the light receiving elements 3 is rotated; etc.

A laser diode that emits laser in the near infrared range is used as the light emitting element 2, and silicon photomultipliers (hereinafter referred to as “SiPM”; SiPM stands for Silicon Photo Multipliers) with a matrix arrangement of a plurality of single photon avalanche diodes (hereinafter referred to as “SPAD”; SPAD stands for Single Photon Avalanche Diode) are used as the light receiving elements 3.

When a photon enters an avalanche photodiode (hereinafter referred to as “APD”; APD stands for Avalanche Photo Diode), an electron-hole pair is created, and each of the electron and the hole are accelerated in a high electric field to cause impact ionization one after another like an avalanche to create a new electron-hole pair.

An operation mode of the APD includes a linear mode in which the APD operates with a reverse bias voltage less than a breakdown voltage, and a Geiger mode in which the APD operates with the reverse bias voltage equal to or greater than the breakdown voltage. In the linear mode, by applying and controlling the reverse bias voltage less than the breakdown voltage, it is possible to variably control a multiplication factor. An output current is approximately proportional to an incident light amount, and the multiplication factor, i.e. sensitivity, can vary depending on a value of the reverse bias voltage, allowing for use in measuring the incident light amount. In the Geiger mode, by applying the reverse bias voltage equal to or greater than the breakdown voltage, an incidence of a single photon triggers an avalanche phenomenon.

In the SPAD, it is possible to nondestructively stop an avalanche by decreasing the applied voltage of the APD to the breakdown voltage. Decreasing the applied voltage to stop the avalanche phenomenon is called quenching. The simplest quenching circuit is implemented by connecting a quenching register in series with the APD. When an avalanche current occurs, the bias voltage of the APD decreases due to the voltage increase between terminals of the quenching register, and when the bias voltage becomes less than the breakdown voltage, the avalanche current stops. Thereafter, the applied voltage of the APD exceeds the breakdown voltage again, resulting in a capable state to detect light, but until then there is a dead period during which the SPAD is not responsive.

In a case of using a photon counting type light receiving element that outputs a voltage pulse in response to an incidence of a photon, such as the SPAD, it is possible to repeatedly measure an arrival time of the voltage pulse to generate a histogram and extract a maximum value thereof, thereby eliminating influence of ambient light.

The control circuit 100 includes a motor drive circuit 20, a light emission control circuit 30, a light receiving circuit 40, a time-of-flight measurement circuit 50, a histogram generating circuit 60, a representative value calculation circuit 70, and a distance calculation circuit 80.

The motor drive circuit 20 drives the motor 13 such that the deflection mirror 11 rotates at a predetermined speed based on a pulse signal output from the encoder 14. As the motor 13, a brushless DC motor, a stepping motor, or the like is suitably used.

The light emission control circuit 30 controls the light emitting element 2 to emit the pulsed measurement light at predetermined periods based on the pulse signals output from the encoder 14. For example, when the rotation speed of the deflection mirror 11 (motor 13) is set to 1200 rpm (50 msec. per rotation) and resolution of scan angles of the measurement light or a unit scan angle is set to 0.25°, emission of the pulsed measurement light at 28.8 kHz allows the measurement light to be emitted in units of 0.25°. Note that the numerical values described above are merely illustrative and the present invention is not limited to these numerical values. The same applies to the numerical values illustrated below.

In practice, as described later, pulsed light with a pulse width of 1 nsec. is emitted 16 times at intervals of about 2 usec. during the unit scan angle of 0.25°. Based on the output from the respective light receiving elements 3 that have detected the reflected light for the respective pulsed light, the time-of-flight measurement circuit 50 calculates a time of flight, that is, a time from when the measurement light is emitted until it returns after reflected by the object, and the histogram generating circuit 60 generates a histogram.

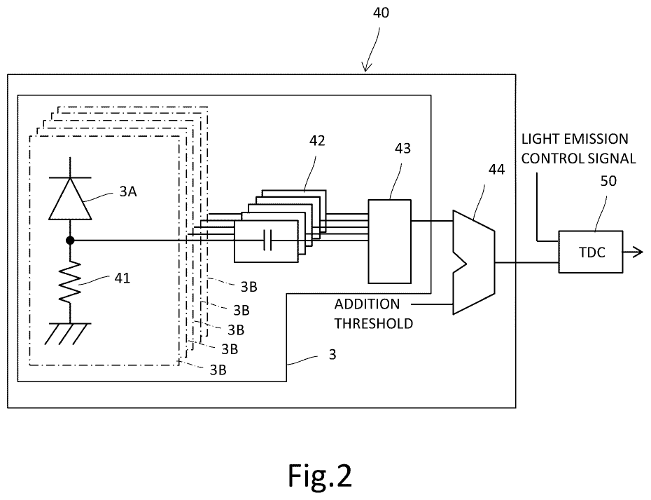

As shown in FIGS. 1 and 2, the light receiving circuit 40 includes the light receiving elements (SiPM) 3 and a comparator circuit 44 to output a pulse when the output by the light receiving elements (SiPM) reaches a predetermined addition threshold. The light receiving elements (SiPM) 3 include a plurality of SPADs 3B consisting of an avalanche photodiode 3A in the Geiger mode and a quenching register 41, and a plurality of pulse shaping circuits 42 that is a differentiating circuit including a capacitor to shape the output of the SAPDs 3B into a short pulse wave, and further includes an adder circuit 43 to add the short pulse wave output from the respective pulse shaping circuits 42. Note that the number of the SPADs constituting the SiPM generally consists of about 130 to 6000 elements per pixel, and the light receiving elements (SiPM) 3 generate SiPM output having an output waveform corresponding to the number of the SPADs that have detected a photon.

The time-of-flight measurement circuit 50 is configured with a TDC circuit (TDC: Time-to-Digital Converter) that calculates, as the time of flight, a time from a rising time of a light emission control signal output from the light emission control circuit 30 to a rising time of an output signal from the comparator circuit 44 (specifically, from an emission time point of the measurement light to a time point at which a sum (SiPM output) from the adder circuit 43 reaches the predetermined addition threshold), that is, a time from the emission time point of the measurement light to a detection time point of the reflected light.

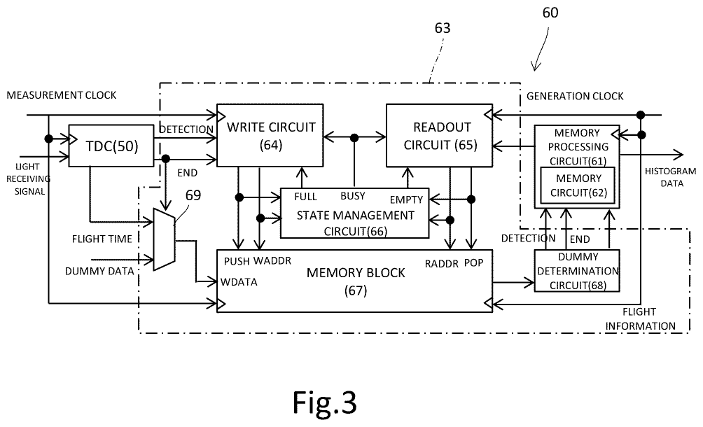

FIG. 3 illustrates one example of the histogram generating circuit 60. The histogram generating circuit 60 generates a histogram showing a frequency distribution of the times of flight, as calculated by the time-of-flight measurement circuit 50 when the measurement light is repeatedly emitted at predetermined periods, in each range on a time axis which is split into a plurality of ranges at predetermined time intervals.

As described later in detail, the histogram generating circuit 60 includes: a memory circuit 62 to store the histogram; a memory processing circuit 61 having a function to generate the histogram based on the output from the time-of-flight measurement circuit 50 and store the histogram in the memory circuit 62; and a FIFO-type memory circuit 63 to relay the time of flight between the time-of-flight measurement circuit 50 and the memory processing circuit 61.

The representative value calculation circuit 70 calculates a representative value of the times of flight for the object from the times distributed in the range where the frequency reaches a predetermined histogram threshold based on the histogram. The distance calculation circuit 80 calculates the distance to the object based on the representative value of the times of flight calculated by the representative value calculation circuit 70.

The time-of-flight measurement circuit 50, the histogram generating circuit 60, the representative value calculation circuit 70, and the distance calculation circuit 80 described above can be integrally configured using FPGA (Field Programmable Gate Array), for example.

The reflected light for the pulsed measurement light emitted from the light emitting element 2 toward the object is detected by the plurality of SPADs included in the SiPM as the light receiving elements 3, and voltage pulses output from the respective SPADs and subjected to wave shaping in the pulse shaping circuits 42 are added by the adder circuit 43. The time of flight from the emission time point of the measurement light to the time point at which the sum from the adder circuit 43 reaches the predetermined addition threshold is calculated by the time-of-flight measurement circuit 50, resulting in occurrence of flight information.

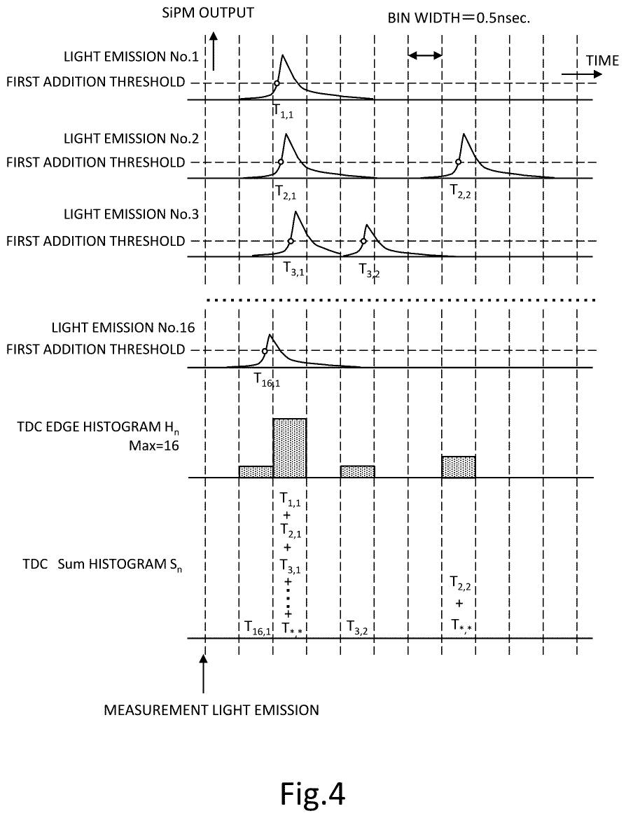

As shown in FIG. 4, the histogram is generated by the histogram generating circuit 60 based on each time of flight (in FIG. 4, denoted as “TDC COUNT VALUE T_{m,n}, m IS LIGHT EMISSION NUMBER, n IS EDGE DETECTION NUMBER”) calculated by the time-of-flight measurement circuit 50 for the measurement light repeatedly emitted (repeatedly emitted 16 times in the present embodiment) at predetermined periods (about 500 kHz in the present embodiment) during the unit scan angle (0.25° in the present embodiment), the histogram showing the frequency distribution (Max. value is 16) of the times of flight corresponding to each range on the time axis which is split into the plurality of ranges (in FIG. 4, each range is denoted as “BIN”) at the predetermined time intervals (in FIG. 4, 0.5 nsec.). The bin refers to one division obtained by equally dividing the time of flight corresponding to an interval between the shortest distance and the longest distance of a measurable range by the optical rangefinder 200 at the predetermined time intervals, or one division obtained by equally dividing the distance between the shortest distance and the longest distance of the same at predetermined distance intervals.

Specifically, the time of flight corresponds to an interval between the emission time point of the measurement light and the time point at which an output value by the adder circuit 43 reaches the predetermined addition threshold. A TDC edge histogram or a frequency Hn is obtained by adding the number of presence of the times of flight in each bin, and a TDCSUM histogram or a total time of flight Sn is obtained by adding the times of flight present in each bin.

Then, from the times of flight distributed in the bin where the frequency Hn reaches the predetermined histogram threshold, the representative value of the times of flight for the object is calculated (Sn/Hn) by the representative value calculation circuit 70. Further, based on the representative value of the times of flight calculated by the representative value calculation circuit 70, the distance calculation circuit 80 calculates the distance to the object.

The representative value calculation circuit 70 calculates, as the representative value of the times of flight for the object, a value obtained by dividing the total time of flight Sn, which is a total sum of the times of flight distributed in the range where the frequency Hn reaches the predetermined histogram threshold, by a value of the frequency Hn based on the histogram. In the example of FIG. 4, the representative value is obtained by dividing Sn=T_{1.1}+T_{2.1}+T_{3,1}+ . . . +T_{*,*} by the value of the frequency Hn.

Although in the example of FIG. 4, the representative value is calculated only for the bin where the frequency reaches the predetermined histogram threshold, the representative value calculation circuit 70 may calculate, as the representative value of the times of flight for the object, a value obtained by dividing a total sum of the times of flight distributed in the bin where the frequency reaches the predetermined histogram threshold and the bin adjacent thereto by a sum of the respective frequencies for the corresponding bins based on the histogram.

It is also assumed that the frequency of the histogram exists across the respective ranges on the time axis, which is split into a plurality of bins. Even in such case, based on the histogram, the representative value of the times of flight for the object can be calculated by dividing a total sum of the times of flight distributed in the bin where the frequency reaches the predetermined histogram threshold and the bin adjacent thereto by a sum of the respective frequencies for the corresponding bins, thereby obtaining a more accurate value as the representative value. In this case, the bin adjacent to the bin where the frequency reaches the predetermined histogram threshold may be the range with the greater frequency among the adjacent bins on left and right sides of the bin with the maximum frequency, or may be both of the adjacent ranges.

Further, when the frequency in a single bin does not reach the predetermined histogram threshold but a total sum of the frequencies distributed in a plurality of bins reaches the histogram threshold, a value obtained by dividing a total sum of the times of flight distributed in the plurality of bins by the sum of the respective frequencies of the corresponding bins may be employed as the representative value of the times of flight for the object. As a result, a more accurate value can be obtained as the representative value. The accurate representative value can be obtained by reducing influence of chattering in which the frequencies are dispersed in the adjacent bins of the histogram.

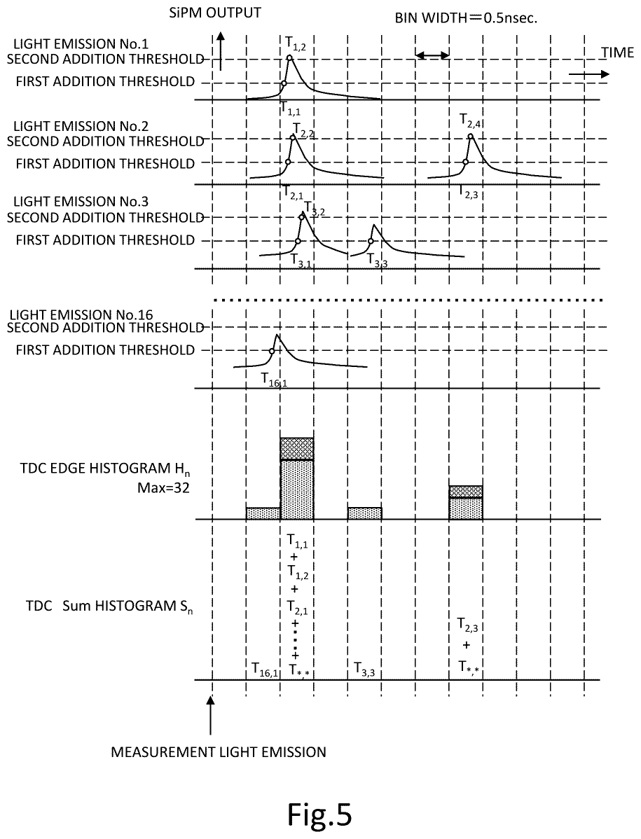

Yet further, as shown in FIG. 5, the time-of-flight measurement circuit 50 may be configured to calculate, as the time of flight, each of times from the emission time point of the measurement light to a time point at which an output value from the adder circuit 43 reaches a predetermined addition threshold (first addition threshold) and to a time point at which the output value reaches an addition threshold (second addition threshold) greater than the predetermined addition threshold.

The histogram generating circuit 60 is configured to generate a histogram showing a cumulative frequency distribution of the respective times of flight, as calculated in the time-of-flight measurement circuit 50 when the measurement light is repeatedly emitted at predetermined periods, in each range on a time axis which is split into a plurality of ranges (bins) at predetermined time intervals.

Then, the representative value calculation circuit 70 may be configured to calculate, as the representative value of the times of flight for the object, a value obtained by dividing a total sum of the respective times of flight corresponding to the predetermined addition threshold among the times of flight distributed in the range (bin) where the frequency reaches the predetermined histogram threshold by the frequency corresponding to the predetermined addition threshold, based on the histogram.

In this case, as shown in FIG. 5, a maximum value (Max) of the edge detection number n indicated in the “TDC COUNT VALUE T_{m, n}” is 32, that can give an equivalent effect to expansion of a dynamic range of the histogram.

Hereinafter, the histogram generating circuit 60 will be described in detail based on FIG. 3.

The histogram generating circuit 60 is a circuit block to generate the histogram showing the cumulative frequency of the flight information distributed in a preset measurement range based on the respective flight information, that is, the time of flight or a flight distance from the emission time point of the measurement light repeatedly emitted at predetermined periods to the detection time point of the reflected light for the respective measurement light.

In the present embodiment, an example will be described, where the time of flight output from the time-of-flight measurement circuit 50 is targeted as the flight information as described above. However, the flight distance calculated from the time of flight until the measurement light emitted from the light emitting element 2 is reflected by the object and detected by the plurality of light receiving elements 3 may be targeted as the flight information. Note that the flight information may further include other information such as a light reception level or a time width of a light reception signal, as long as it includes at least the time of flight or the flight distance. The histogram generating circuit 60 includes the FIFO-type memory circuit 63, the memory circuit 62 to store the histogram, and the memory processing circuit 61 to associate a bin number for identifying each bin obtained by splitting the measurement range into a plurality of divisions individually in order based on the flight information with the times of flight contained in each bin and the cumulative frequency, and store them in the memory circuit 62. The bin number may be information that enables individual identification of an order of each bin. If the bin number is set to increase or decrease in sequence in accordance with the time of flight or the flight distance from the emission time point of the measurement light, for example, it becomes easy to use for sorting in ascending or descending order.

Since the memory processing circuit 61 associates the flight information including the occurred time of flight with the bin number of the bin to which the time of flight belongs and stores them in the memory circuit 62, there is no need to secure in advance a memory area corresponding to the bin with no occurrence of the time of flight in the memory circuit 62, allowing to reduce a memory capacity of the memory circuit 62. Further, in a case that a plurality of times of flight occur for the same bin number, the memory processing circuit 61 can associate that bin number with the cumulative frequency, thereby generating the histogram showing the distribution of the times of flight in the preset measurement range.

The FIFO-type memory circuit 63 includes a memory block 67, a write circuit 64 to control data writing in the memory block 67, a readout circuit 65 to control readout of data from the memory block 67, a state management circuit 66, and the like.

The write circuit 64 is a block to control timing and a write address to write the time of flight in the memory block 67 in synchronization with the occurrence of the time of flight from the time-of-flight measurement circuit 50. The readout circuit 65 is a block to control timing and a read address to read out the time of flight written in the memory block 67 by the write circuit 64. Additionally, the state management circuit 66 is a block to manage a free space of the memory block 67, as well as access to the memory block 67 by the write circuit 64 and the read circuit 65 to prevent them from conflicting with each other.

The write circuit 64 manages the write address of the memory block 67; controls to write the time of flight from the time-of-flight measurement circuit 50 in the memory block 67; and updates an address counter each time to manage the address to write in next, based on a signal from the state management circuit 66. The readout circuit 65 controls to read out the time of flight from the memory block 67 to a dummy determination circuit 68, and updates an address counter each time to manage the address to read out next, based on a signal from the state management circuit 66.

The state management circuit 66 manages a remaining capacity of the memory block 67 to output the signal corresponding to the write circuit 64 to prevent further writing when the memory becomes full, and output the signal corresponding to the readout circuit 65 to prevent further readout when the memory becomes empty.

The time-of-flight measurement circuit 50, the memory block 67, and the write circuit 64 operate in synchronization with a measurement clock having a predetermined period to control the light emission control circuit 30 and the like, thereby executing a sequence of writing the time of flight in the memory block 67, whereas the memory processing circuit 61, the memory circuit 62, the memory block 67, and the readout circuit 65 operate in synchronization with a generation clock of the histogram, thereby executing a sequence of reading out the time of flight from the memory block 67.

In other words, the write circuit 64 operates to store the flight information in synchronization with the measurement clock specifying an occurrence time of the time of flight from the time-of-flight measurement circuit 50, whereas the readout circuit 65 outputs the flight information to the dummy determination circuit 68 and eventually the memory processing circuit 61 in synchronization with the generation clock of the histogram, which is asynchronous to the occurrence of the time of flight.

The write circuit 64 includes a dummy data adding circuit 69 to store dummy data indicating an end of output of the flight information in one period in the memory block 67 every time the output of the time of flight from the time-of-flight measurement circuit 50 ends at a predetermined period, that is, a light emission period of the pulsed light.

The readout circuit 65 includes the dummy determination circuit 68 to output the time of flight to the memory processing circuit 61 every time when reading out the time of flight from the memory block 67, and output a signal indicating an end of output of the time of flight occurred in one period of the light emission period of the pulsed light to the memory processing circuit 61 when reading out the dummy data from the memory block 67. The memory processing circuit 61 determines whether or not the flight information is the one within one period of the light emission period of the pulsed light based on the dummy data.

Even when the time-of-flight measurement circuit 50 detects a plurality of times of flight within one period and an occurrence interval between the respective times of flight is short, it is possible to secure a time to update the histogram based on the respective flight information subsequently read out from the FIFO-type memory circuit 63 by buffering the respective times of flight in the FIFO-type memory circuit 63, causing no inconvenience of data loss.

Hereinafter, operation of the memory processing circuit 61 will be described in detail.

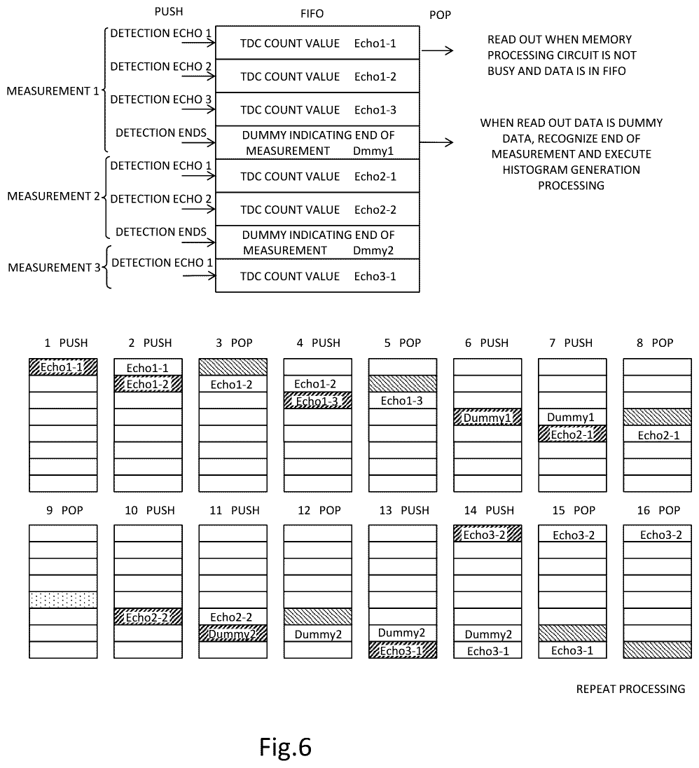

As shown in the upper part of FIG. 6, every time the time of flight (in FIG. 6, referred to as “DETECTION ECHO”/“” TDC COUNT VALUE″) is output from the time-of-flight measurement circuit 50 at each light emission period of the pulsed light, a TDC count value is stored (PUSH) in the memory block 67 by the write circuit 64.

In the light emission period of the pulsed light denoted as “MEASUREMENT 1”, three “DETECTION ECHO” output from the time-of-flight measurement circuit 50 are stored (PUSH) in the memory block 67 by the write circuit 64, and further the dummy data indicating the end of the measurement is stored (PUSH) by the dummy data adding circuit 69. In the light emission period of the pulsed light denoted as “MEASUREMENT 2”, two “DETECTION ECHO” output from the time-of-flight measurement circuit 50 are stored (PUSH) in the memory block 67 by the write circuit 64, and further the dummy data indicating the end of the measurement is stored (PUSH) by the dummy data adding circuit 69.

The time of flight stored (PUSH) in the memory block 67 is read out (POP) by the readout circuit 65 to the dummy determination circuit 68 when the memory processing circuit 61 is not busy and the data is being stored in the memory block 67. When the read out data is determined as the dummy data by the dummy determination circuit 68, it is determined that the measurement for one light emission period of the pulsed light has been completed and an end signal indicative thereof is output to the memory processing circuit 61. The memory processing circuit 61 generates the histogram based on the times of flight input from the dummy determination circuit 68 until the end signal is detected.

Illustrated in the lower part of FIG. 6 is a sequence in which each time of flight is stored (PUSH) in the order shown in the upper part in the memory block 67 by the write circuit 64, and each time of flight is read out (POP) from the memory block 67 by the readout circuit 65 asynchronously to the writing by the write circuit 64.

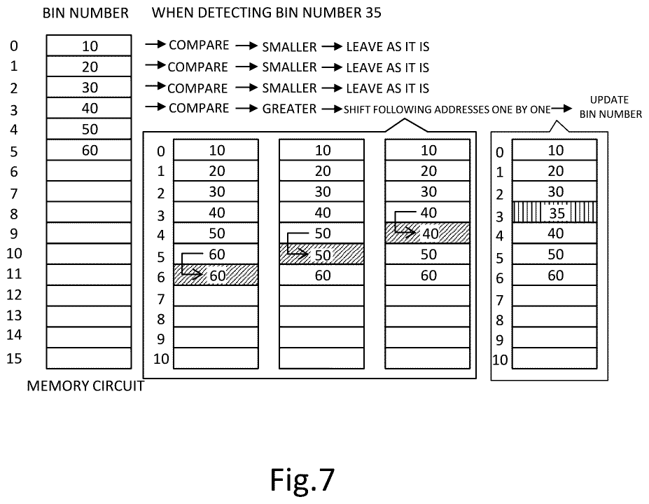

FIG. 7 illustrates an aspect in a case that the memory circuit 62 is configured with a single memory circuit. An example will be described, where the memory processing circuit 61 calculates the bin number as “35”, to which the time of flight input from the dummy determination circuit 68 belongs. In the left end, the bin numbers stored in the memory circuit 62 at that time are shown. Note that the memory circuit 62 stores data on the bin numbers such as the bin numbers, the frequency, and the times of flight.

The memory processing circuit 61 compares the new bin number “35” with the bin number already stored in the memory circuit 62. When determining that the bin number stored in the memory circuit 62 is smaller than the new bin number “35”, it maintains the memory state as it is, and when determining that the bin number stored in the memory circuit 62 is greater than the new bin number “35”, it stores the greater bin numbers in the respective memory addresses shifted one by one and stores the new bin number “35” in an empty address. In FIG. 7, the memory addresses of the bin numbers “60”, “50”, and “40” are changed, and the bin number “35” is stored in the memory address in which the bin number “40” has been stored. Note that when the bin numbers stored in the memory circuit 62 already include “35”, “1” is added to the frequency for the bin number 35.

In other words, once the flight information occurs, the memory processing circuit 61 reads out the bin numbers stored in the memory circuit 62, sorts the bin numbers including the one to which the flight information occurred this time belongs in ascending or descending order, and stores the bin numbers, the flight information, and the cumulative frequency in the memory circuit 62. Switching between the ascending and descending orders depends on whether the write address is incremented or decremented in order.

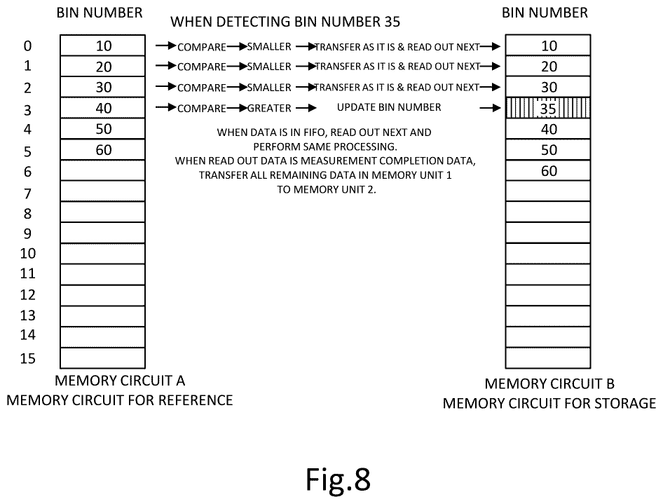

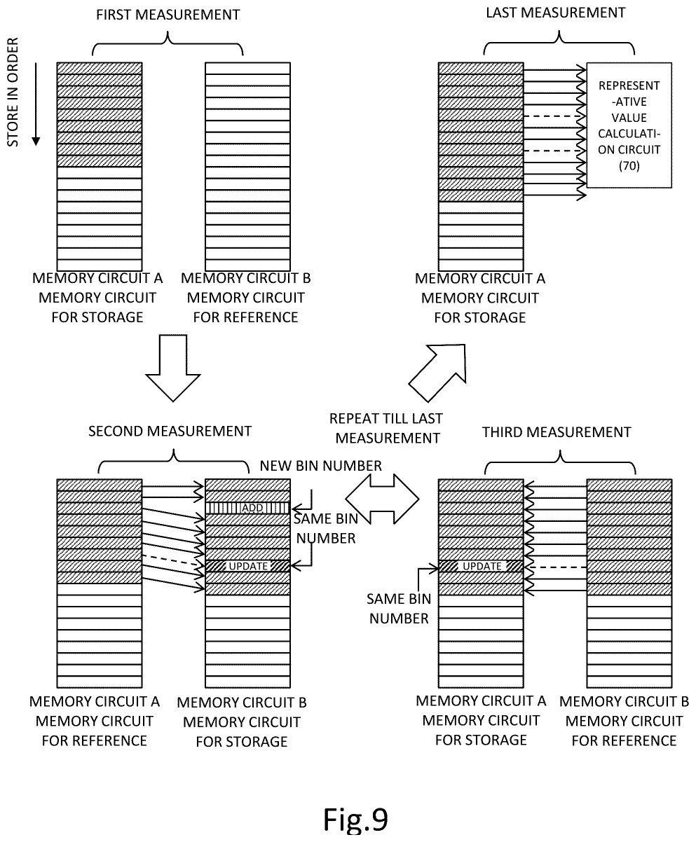

FIGS. 8 and 9 illustrate an aspect in a case where the memory circuit 62 is configured with two memory circuits (memory circuit A, memory circuit B). One of the memory circuit A and the memory circuit B functions as a memory circuit for reference to grasp the already stored bin number, and the other functions as a memory circuit for storage to store the bin numbers including the new bin number and the cumulative frequency when the flight information occurs.

For each occurrence of the flight information, the memory processing circuit 61 switches the functions of the memory circuit for reference and the memory circuit for storage; reads out the bin number stored in the memory circuit for reference; sorts the bin numbers including the one to which the time of flight information occurred this time belongs in ascending or descending order; and stores the bin numbers, the flight information, and the cumulative frequency in the memory circuit for storage.

In other words, two memory circuits are provided as the memory circuit 62: the memory circuit for reference to grasp the already stored bin number and the memory circuit for storage to store the bin numbers including the new bin number and the cumulative frequency. Based on the bin numbers and the cumulative frequency stored in the memory circuit for storage by the memory processing circuit 61, the most recent histogram will be created.

When new flight information occurs, the memory processing circuit 61 causes the memory circuit for storage to function as the memory circuit for reference, and compares the bin number read out from the memory circuit for reference with the bin number to which the new flight information belongs. Then, it sorts the respective bin numbers in ascending or descending order, and stores the bin numbers, the flight information, and the cumulative frequency in the memory circuit for storage whose function is switched from the memory circuit for reference. By separating the functions into the memory circuit for reference and the memory circuit for storage, it is possible to simultaneously perform readout processing from one of the memory circuits and write processing in the other memory circuit, increasing a processing speed as compared to a case of using a single memory circuit.

In the example of FIG. 8, the memory circuit A functions as the memory circuit for reference and the memory circuit B functions as the memory circuit for storage. Similar to the above, an example will be described, where the memory processing circuit 61 calculates the bin number as “35”, to which the time of flight input from the dummy determination circuit 68 belongs. The leftmost figure illustrates the bin numbers at that time stored in the memory circuit A functioning as the memory circuit for reference. Note that the memory circuit A stores data such as the bin numbers, the frequency, and the times of flight as described above.

The memory processing circuit 61 compares the new bin number “35” with the bin number stored in the memory circuit for reference (memory circuit A), and when determining that the bin number stored in the memory circuit for reference (memory circuit A) is smaller than the new bin number “35”, stores the data on the bin number stored in the memory circuit for reference (memory circuit A) in the memory circuit for storage (memory circuit B) in the same order as it is. When determining that the bin number stored in the memory circuit for reference (memory circuit A) is greater than the new bin number “35”, the memory processing circuit 61 stores the data on the new bin number “35” in the next address in the memory circuit for storage (memory circuit B), and further stores the data on the bin number, which is stored in the memory circuit for reference (memory circuit A) and greater than the new bin number “35”, in the following address in the memory circuit for storage (memory circuit B). Note that when the bin numbers stored in the memory circuit for reference (memory circuit A) already include “35”, “1” is added to the frequency for the bin number 35, which is stored in the memory circuit for storage (memory circuit B).

Furthermore, at first occurrence of the flight information, the memory processing circuit 61 stores the bin number, the time of flight, and the cumulative frequency in the memory circuit for storage without switching the functions of the memory circuit for reference and the memory circuit for storage. At the first occurrence of the flight information, there is no need to compare the bin numbers, so that any one of the memory circuits may function as the memory circuit for storage to store the bin number, the flight information, and the cumulative frequency (“1” in this case).

FIG. 9 illustrates a procedure for switching the functions of the memory circuit for reference and the memory circuit for storage to update the histogram data by the memory processing circuit 61 at each measurement until the dummy data is input by the dummy determination circuit 68. After the last measurement, the data on the bin numbers stored in the memory circuit for storage is output to the representative value calculation circuit 70 to calculate the representative value, and further the distance is calculated by the distance calculation circuit.

Described in the above embodiment is the configuration in which the histogram generating circuit 60 includes the FIFO-type memory circuit 63. However, the histogram generating circuit 60 may be configured without the FIFO-type memory circuit 63. In this case, it may be configured that measurement information from the time-of-flight measurement circuit 50 is directly output to the memory processing circuit 61, and the memory processing circuit 61 updates and stores the histogram data in the single memory circuit 62 described with reference to FIG. 7, or in a pair of the memory circuits 62 shown in FIGS. 8 and 9 each time. However, it should be noted that if an output interval of the measurement information from the time-of-flight measurement circuit 50 is very short, there is a risk of damage to the histogram data updated and stored in the memory circuit 62.

As described above, the histogram generation method in accordance with the present invention is a method for generating a histogram based on respective flight information that is a time of flight or a flight distance from an emission time point of measurement light repeatedly emitted at predetermined periods to a detection time point of reflected light for respective measurement light, the histogram showing a cumulative frequency of the flight information distributed in a preset measurement range, the method including: a memory step of storing the histogram in a memory circuit; and a memory processing step of associating a bin number for identifying each bin obtained by splitting the measurement range into a plurality of divisions individually in order based on the flight information with the flight information contained in each bin and the cumulative frequency, and storing them in the memory circuit.

Further, the optical rangefinder in accordance with the present invention includes: a light emitting element configured to emit pulsed measurement light; a plurality of photon counting type light receiving elements configured to detect reflected light from an object for the measurement light; an adder circuit configured to add voltage pulses output from the respective light receiving elements; a flight information calculation circuit configured to calculate, as flight information, time from an emission time point of the measurement light to a time point at which a sum from the adder circuit reaches a predetermined addition threshold, or a distance corresponding to the time; a histogram generating circuit configured to generate a histogram showing a cumulative frequency of the flight information distributed in a preset measurement range based on the flight information calculated by the flight information calculation circuit when the measurement light is repeatedly emitted at predetermined periods; a representative value calculation circuit configured to calculate a representative value of the flight information for the object from the flight information that is distributed in the bin of the bin number where the frequency reaches a predetermined histogram threshold based on the histogram; and a distance calculation circuit configured to calculate a distance to the object based on the representative value of the flight information calculated by the representative value calculation circuit.

Yet further, the optical ranging method in accordance with the present invention includes: a reflected light detection step of detecting reflected light from an object for pulsed measurement light emitted from a light emitting element using a plurality of photon counting type light receiving elements; a flight information calculation step of calculating, as flight information, a time from an emission time point of the measurement light to a time point at which a sum of voltage pulses output from the respective light receiving elements reaches a predetermined addition threshold, or a distance corresponding to the time; a histogram generation step of performing a histogram generation method, generating a histogram showing a cumulative frequency of the flight information distributed in a preset measurement range based on the flight information calculated in the flight information calculation step when the measurement light is repeatedly emitted at predetermined periods; a representative value calculation step of calculating a representative value of the flight information for the object from the flight information distributed in the bin of the bin number where the frequency reaches a predetermined histogram threshold based on the histogram; and a distance calculation step of calculating a distance to the object based on the representative value of the flight information calculated in the representative value calculation step. The foregoing embodiment is merely an example of the present invention, and the description of the embodiment is not intended to limit the scope of the present invention.

### REFERENCE SIGNS LIST

2: Light emitting element
3: Light receiving element
10: Optical scanning device
20: Motor drive circuit
30: Light emission control circuit
40: Light receiving circuit
50: Time-of-flight measurement circuit
60: Histogram generating circuit
61: Memory processing circuit
62: Memory circuit
63: FIFO-type memory circuit
64: Write circuit
65: Readout circuit
66: State management circuit
67: Memory block
68: Dummy determination circuit
69: Dummy data adding circuit
70: Representative value calculation circuit
80: Distance calculation circuit
100: Control circuit
200: Optical rangefinder

1. A histogram generating circuit that generates a histogram based on respective flight information that is a time of flight or a flight distance from an emission time point of measurement light repeatedly emitted at predetermined periods to a detection time point of reflected light for respective measurement light, the histogram showing a cumulative frequency of the flight information distributed in a preset measurement range, the histogram generating circuit comprising:
a memory circuit configured to store the histogram; and
a memory processing circuit configured to associate a bin number for identifying each bin obtained by splitting the measurement range into a plurality of divisions individually in order based on the flight information with the flight information contained in each bin and the cumulative frequency, and store the bin number, the flight information, and the cumulative frequency in the memory circuit.

2. The histogram generating circuit according to claim 1, wherein when the flight information occurs, the memory processing circuit reads out the bin number stored in the memory circuit, sorts the flight information in ascending or descending order by the bin numbers including the one of the bin to which the flight information occurred this time belongs, and stores the bin numbers, the flight information, and the cumulative frequency in the memory circuit.

3. The histogram generating circuit according to claim 1, comprising, as the memory circuit, a memory circuit for reference to grasp an already stored bin number and a memory circuit for storage to store bin numbers including a new bin number and the cumulative frequency when the flight information occurs, wherein the memory processing circuit is configured to switch functions of the memory circuit for reference and the memory circuit for storage for each occurrence of the flight information; read out a bin number stored in the memory circuit for reference; sort the flight information in ascending or descending order by the bin numbers including the one to which the flight information occurred this time belongs; and store the bin numbers, the flight information, and the cumulative frequency in the memory circuit for storage.

4. The histogram generating circuit according to claim 3, wherein the memory processing circuit stores the bin number, the flight information, and the cumulative frequency in the memory circuit for storage without switching the functions of the memory circuit for reference and the memory circuit for storage at first occurrence of the flight information.

5. The histogram generating circuit according to claim 1, further comprising a FIFO-type memory circuit,
wherein the FIFO-type memory circuit includes a write circuit configured to store the flight information in synchronization with occurrence of the flight information, and a readout circuit configured to read out and output the flight information to the memory processing circuit asynchronously to the occurrence of the flight information.

6. The histogram generating circuit according to claim 5, wherein the write circuit is configured to store dummy data indicating an end of output of the flight information in one period in the FIFO-type memory circuit every time the output of the flight information ends at the predetermined periods, and the readout circuit is configured to output a signal indicating an end of output of the flight information in one period every time when reading out the dummy data.

7. An optical rangefinder, comprising:
a light emitting element configured to emit pulsed measurement light;
a plurality of photon counting type light receiving elements configured to detect reflected light from an object for the measurement light;
an adder circuit configured to add voltage pulses output from the respective light receiving elements;
a flight information calculation circuit configured to calculate, as flight information, time from an emission time point of the measurement light to a time point at which a sum from the adder circuit reaches a predetermined addition threshold, or a distance corresponding to the time;
a histogram generating circuit according to claim 1, configured to generate a histogram showing a cumulative frequency of the flight information distributed in a preset measurement range based on the flight information calculated by the flight information calculation circuit when the measurement light is repeatedly emitted at predetermined periods;
a representative value calculation circuit configured to calculate a representative value of the flight information for the object from the flight information that is distributed in the bin of the bin number where the frequency reaches a predetermined histogram threshold based on the histogram; and
a distance calculation circuit configured to calculate a distance to the object based on the representative value of the flight information calculated by the representative value calculation circuit.

8. A histogram generation method for generating a histogram based on respective flight information that is a time of flight or a flight distance from an emission time point of measurement light repeatedly emitted at predetermined periods to a detection time point of reflected light for respective measurement light, the histogram showing a cumulative frequency of the flight information distributed in a preset measurement range, the method comprising:
a memory step of storing the histogram in a memory circuit; and
a memory processing step of associating a bin number for identifying each bin obtained by splitting the measurement range into a plurality of divisions individually in order based on the flight information with the flight information contained in each bin and the cumulative frequency, and storing the bin number, the flight information, and the cumulative frequency in the memory circuit.

9. An optical ranging method, comprising:
a reflected light detection step of detecting reflected light from an object for pulsed measurement light emitted from a light emitting element using a plurality of photon counting type light receiving elements;
a flight information calculation step of calculating, as flight information, a time from an emission time point of the measurement light to a time point at which a sum of voltage pulses output from the respective light receiving elements reaches a predetermined addition threshold, or a distance corresponding to the time;
a histogram generation step of performing a histogram generation method according to claim 8, generating a histogram showing a cumulative frequency of the flight information distributed in a preset measurement range based on the flight information calculated in the flight information calculation step when the measurement light is repeatedly emitted at predetermined periods;
a representative value calculation step of calculating a representative value of the flight information for the object from the flight information distributed in the bin of the bin number where the frequency reaches a predetermined histogram threshold based on the histogram; and
a distance calculation step of calculating a distance to the object based on the representative value of the flight information calculated in the representative value calculation step.

10. An optical rangefinder, comprising:
the light emitting element configured to emit pulsed measurement light;
the plurality of photon counting type light receiving elements configured to detect reflected light from the object for the measurement light;
the adder circuit configured to add voltage pulses output from the respective light receiving elements;
the flight information calculation circuit configured to calculate, as flight information, time from the emission time point of the measurement light to the time point at which the sum from the adder circuit reaches the predetermined addition threshold, or the distance corresponding to the time;
the histogram generating circuit according to claim 2, configured to generate the histogram showing the cumulative frequency of the flight information distributed in the preset measurement range based on the flight information calculated by the flight information calculation circuit when the measurement light is repeatedly emitted at predetermined periods;
the representative value calculation circuit configured to calculate the representative value of the flight information for the object from the flight information that is distributed in the bin of the bin number where the frequency reaches the predetermined histogram threshold based on the histogram; and
the distance calculation circuit configured to calculate the distance to the object based on the representative value of the flight information calculated by the representative value calculation circuit.

11. An optical rangefinder, comprising:
the light emitting element configured to emit pulsed measurement light;
the plurality of photon counting type light receiving elements configured to detect reflected light from the object for the measurement light;
the adder circuit configured to add voltage pulses output from the respective light receiving elements;
the flight information calculation circuit configured to calculate, as flight information, time from the emission time point of the measurement light to the time point at which the sum from the adder circuit reaches the predetermined addition threshold, or the distance corresponding to the time;
the histogram generating circuit according to claim 3, configured to generate the histogram showing the cumulative frequency of the flight information distributed in the preset measurement range based on the flight information calculated by the flight information calculation circuit when the measurement light is repeatedly emitted at predetermined periods;
the representative value calculation circuit configured to calculate the representative value of the flight information for the object from the flight information that is distributed in the bin of the bin number where the frequency reaches the predetermined histogram threshold based on the histogram; and
the distance calculation circuit configured to calculate the distance to the object based on the representative value of the flight information calculated by the representative value calculation circuit.

12. An optical rangefinder, comprising:
the light emitting element configured to emit pulsed measurement light;
the plurality of photon counting type light receiving elements configured to detect reflected light from the object for the measurement light;
the adder circuit configured to add voltage pulses output from the respective light receiving elements;
the flight information calculation circuit configured to calculate, as flight information, time from the emission time point of the measurement light to the time point at which the sum from the adder circuit reaches the predetermined addition threshold, or the distance corresponding to the time;
the histogram generating circuit according to claim 4, configured to generate the histogram showing the cumulative frequency of the flight information distributed in the preset measurement range based on the flight information calculated by the flight information calculation circuit when the measurement light is repeatedly emitted at predetermined periods;
the representative value calculation circuit configured to calculate the representative value of the flight information for the object from the flight information that is distributed in the bin of the bin number where the frequency reaches the predetermined histogram threshold based on the histogram; and
the distance calculation circuit configured to calculate the distance to the object based on the representative value of the flight information calculated by the representative value calculation circuit.

13. An optical rangefinder, comprising:
the light emitting element configured to emit pulsed measurement light;
the plurality of photon counting type light receiving elements configured to detect reflected light from the object for the measurement light;
the adder circuit configured to add voltage pulses output from the respective light receiving elements;
the flight information calculation circuit configured to calculate, as flight information, time from the emission time point of the measurement light to the time point at which the sum from the adder circuit reaches the predetermined addition threshold, or the distance corresponding to the time;
the histogram generating circuit according to claim 5, configured to generate the histogram showing the cumulative frequency of the flight information distributed in the preset measurement range based on the flight information calculated by the flight information calculation circuit when the measurement light is repeatedly emitted at predetermined periods;
the representative value calculation circuit configured to calculate the representative value of the flight information for the object from the flight information that is distributed in the bin of the bin number where the frequency reaches the predetermined histogram threshold based on the histogram; and
the distance calculation circuit configured to calculate the distance to the object based on the representative value of the flight information calculated by the representative value calculation circuit.

14. An optical rangefinder, comprising:
the light emitting element configured to emit pulsed measurement light;
the plurality of photon counting type light receiving elements configured to detect reflected light from the object for the measurement light;
the adder circuit configured to add voltage pulses output from the respective light receiving elements;
the flight information calculation circuit configured to calculate, as flight information, time from the emission time point of the measurement light to the time point at which the sum from the adder circuit reaches the predetermined addition threshold, or the distance corresponding to the time;
the histogram generating circuit according to claim 6, configured to generate the histogram showing the cumulative frequency of the flight information distributed in the preset measurement range based on the flight information calculated by the flight information calculation circuit when the measurement light is repeatedly emitted at predetermined periods;
the representative value calculation circuit configured to calculate the representative value of the flight information for the object from the flight information that is distributed in the bin of the bin number where the frequency reaches the predetermined histogram threshold based on the histogram; and
the distance calculation circuit configured to calculate the distance to the object based on the representative value of the flight information calculated by the representative value calculation circuit.
